(19) United States
(12) Patent Application Publication
(10) Pub. No.: US 2006/0289677 A1
(43) Pub. Date: Dec. 28, 2006

(54) Spray noozzle

(76) Inventor: Takahiro Yamaguchi, Shizuoka (JP)

Correspondence Address: WENDEROTH, LIND & PONACK, L.L.P., 2033 K STREET N. W., SUITE 800, WASHINGTON, DC, 20006-1021, US

(21) Appl. No.: 11/475,056

(22) Filed: Jun. 27, 2006

(30) Foreign Application Priority Data
Jun. 28, 2005 (JP) 2005-188109

(51) Int. Cl. B05B 1/10

(52) U.S. Cl. 239/284.1

(57) ABSTRACT

The invention provides a spray nozzle in which the position at which the spray fluid strikes a target does not change. The spray nozzle includes an injection port formed long from side to side, a flow path formed cylindrical between a supply port and the injection port, the flow path having a taper section formed on the middle thereof, reducing the flow path cross-sectional area gradually and a tip end being reached to the injection port, wherein upper and lower positions of the taper section at an end portion on the injection port side are offset with respect to each other in the direction of the axis of the flow path.

### BACKGROUND OF THE INVENTION

1. Field of the Invention

The present invention relates to a spray nozzle, used as an automobile windshield washer fluid nozzle or the like.

2. Related Art

A conventional spray nozzle 10 is known in which, as shown in FIG. 8A, the spray fluid enters a flow path 12 from a supply port 11 located at the rear of the nozzle, wherein the cross-sectional area of the flow path is reduced at an intermediate point and the flow restricted, and the spray fluid is guided by exit dispersion guide planes 13, 14 and sprayed from an injection port 15 onto a target such as a windshield or the like (see, for example, JP-A-2002-96718).

However, with the conventional spray nozzle, as shown in FIGS. 8B and 8C, when the spray fluid flows along the inner circumferential wall surface of the flow path 12 and arrives at the point of restriction, the streams of the flow strike each other in disarray and are ejected from the injection port 15 irregularly along one or the other of the dispersion guide planes 13, 14. As a result, with each ejection the position at which the fluid strikes its target changes. Consequently, stabilizing the position at which the fluid is sprayed is desirable.

### SUMMARY OF THE INVENTION

Accordingly, the present invention is conceived as a solution to the foregoing problem.

To solve the foregoing problem and achieve the object of the present invention, the invention provides a spray nozzle comprising an injection port formed long from side to side, a flow path formed cylindrical between a supply port and the injection port, the flow path having a taper section formed on the middle thereof, reducing the flow path cross-sectional area gradually and a tip end being reached to the injection port, wherein upper and lower positions of the taper section at an end portion on the injection port side are offset with respect to each other in the direction of the axis of the flow path.

Preferably a substantially horizontal dispersion plane part along the axis is provided at least ahead of a flow stream produced by upper or lower inner circumferential wall surface of the taper section whose end position in the direction of the axis of the flow path is closer to the injection port.

Preferably, the dispersion plane part is retracted in a direction perpendicular to the axis of the flow path so as not to guide the spray fluid ahead of a flow stream produced by upper or lower inner circumferential wall surface of the taper section whose end position in the direction of the axis of the flow path is farther from the injection port.

According to the spray nozzle of the present invention, the respective streams of the spray fluid flow along the upper and lower inner circumferential wall surfaces of the taper section are gradually constricted toward the injection port so that the streams of the flow strike each other, with the streams of the spray fluid flowing along the upper or lower inner circumferential wall surface of the taper section whose end position in the direction of the axis of the flow path is doser to the injection port being decided first, so that, for example, if the spray fluid flowing from top to bottom is sent first, the spray fluid is sprayed with uniform thickness along the shape of the lower portion of the injection port without flutter.

If a substantially horizontal dispersion plane part along the axis is provided at least ahead of a flow stream produced by upper or lower inner circumferential wall surface of the taper section whose end position in the direction of the axis of the flow path is doser to the injection port, the spray fluid is sprayed horizontally with uniform thickness along the dispersion plane without flutter.

In addition, if a dispersion plane part is retracted in a direction perpendicular to the axis of the flow path so as not to guide the spray fluid ahead of a flow stream produced by upper or lower inner circumferential wall surface of the taper section whose end position in the direction of the axis of the flow path is farther from the injection port, the retracted dispersion plane have no excessive effect on the flow of spray fluid, which is guided only by the horizontal dispersion plane. As a result, the position at which the spray fluid strikes the target does not change with each ejection.

Other features and advantages of the present invention will be apparent from the following description when taken in conjunction with the accompanying drawings, in which like reference characters designate the same or similar parts throughout the figures thereof.

### BRIEF DESCRIPTION OF THE DRAWINGS

FIG. 1 is a plan view of a spray nozzle according to one embodiment of the present invention;

FIG. 2 is a sectional view along a line 2-2 shown in FIG. 1;

FIGS. 3A and 3B are sectional views illustrating schematically a flow of a spray fluid on a flow path of the spray nozzle;

FIG. 4A is a perspective views of the spray nozzle, and FIGS. 4B and 4C are perspective views of an upper half and a lower half, respectively, of a state in which the spray nozzle is cut horizontally along its center;

FIG. 5A is a diagram illustrating results of an analysis of the flow of the spray fluid in the spray nozzle, with FIG. 5B showing a partial enlarged view thereof;

FIG. 6 is a vertical sectional view of a use state of the spray nozzle;

FIG. 7 is a perspective view of a spray state of the spray nozzle; and

FIG. 8A is a vertical sectional view of a conventional spray nozzle, with FIGS. 8B and 8C illustrating the flow of respective streams of spray fluid.

### DETAILED DESCRIPTION OF THE PREFERRED EMBODIMENTS

A detailed description will now be given of a preferred embodiment of the present invention, with reference to the accompanying drawings.

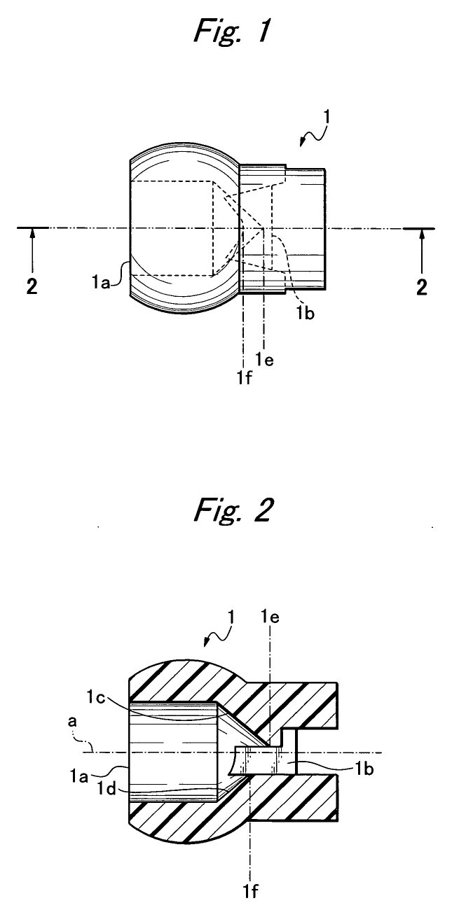

A spray nozzle 1 according to the present invention is used, for example, as a washer nozzle for spraying cleaner fluid onto the front windshield of an automobile. As shown in FIGS. 1 and 2, in a flow path formed cylindrical and extending from a supply port 1a to an injection port 1b formed long from side to side, a taper section is formed by upper and lower halves of inner circumferential wall surfaces 1c, 1d that reduce the flow path cross-sectional area gradually and the tip end reach to the injection port 1b. The upper and lower positions 1e and 1f of the taper section 1c, 1d at an end portion on the injection port side are offset with respect to each other in the direction of the axis of the flow path. In the embodiment shown in the drawings, the upper end position 1e, as shown in FIG. 2, is disposed closer to the injection port 1b than the lower end position 1f.

It should be noted that, with respect to positions 1e, 1f, it is a matter of design preference which of these is positioned doser to the injection port 1b, as is rotating the spray nozzle 1 by its supporting portion. Moreover, the extent of the offset of the positions 1e, 1f along the axis of the flow path is set appropriately according to relations between inclination degrees of the taper section 1c, 1d and the spouting rate of the spray fluid 2, and the like.

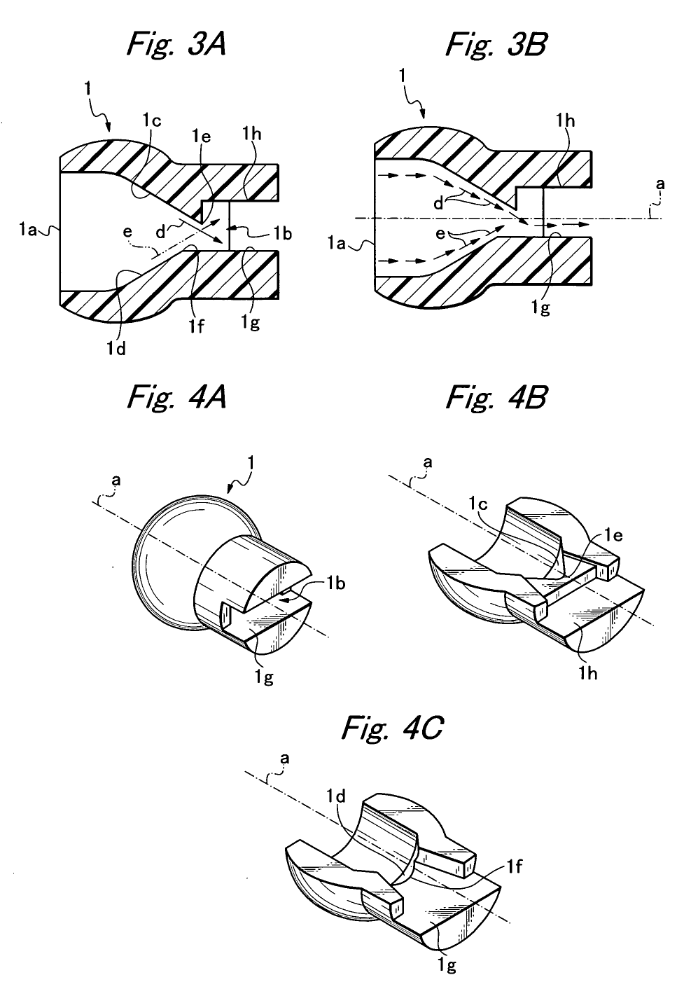

In addition, as shown in FIG. 3A, a substantially horizontal dispersion plane part 1g along the axis “a” is provided ahead of a flow stream “d” produced by upper inner circumferential wall surface 1c of the taper section whose end position 1e in the direction of the axis of the flow path is closer to the injection port 1b, which extends horizontally from the lower section of the injection port 1b.

As shown in FIGS. 4A and 4C, the dispersion plane part 1g broadens laterally as it extends in a direction away from the ejection port 1b. Further, as shown in FIG. 3A, a dispersion plane part 1h is retracted in a direction perpendicular to the axis “a” of the flow path (in the drawing, above the axis) so as not to guide the spray fluid ahead of a flow stream “e” produced by the lower inner circumferential wall surface 1d of the taper section whose end position 1f in the direction of the axis of the flow path is farther from the injection port 1b. Depending on the circumstances, the dispersion plane part 1h may be dispensed with.

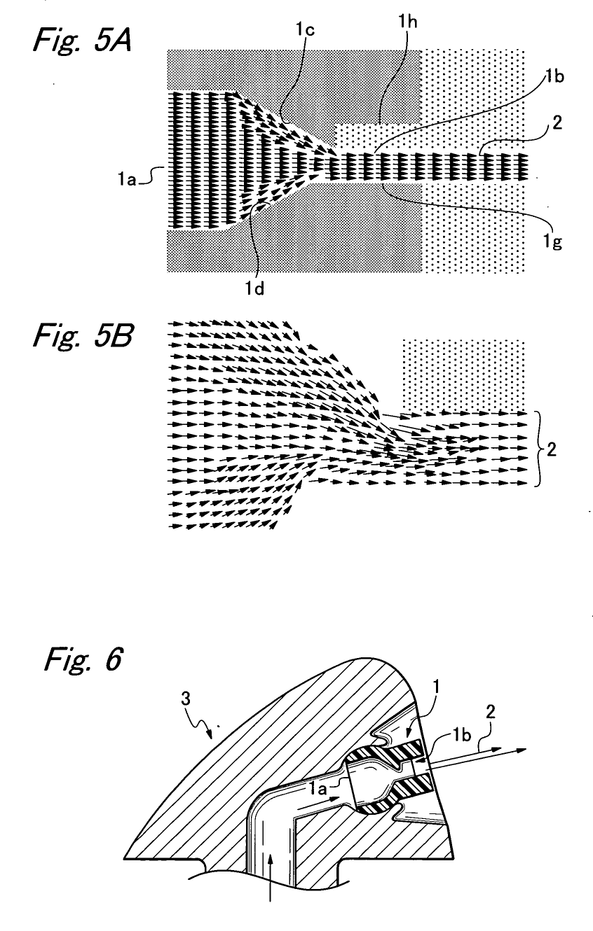

When the state of the fluid ejection of the spray nozzle 1 constructed as described above is tested, as shown in FIG. 5A and in the partial enlarged detail shown in FIG. 5B, the speed of the flow increases from the supply port 1a along the gradually narrowing taper section 1c, 1d to the injection port 1b and the rectified spray fluid 2 is ejected along the dispersion plane 1g.

The foregoing results because top-side spray fluid flowing along the upper inner circumferential wall surface 1c restrains bottom-side spray fluid flowing along the lower inner circumferential wall surface 1d and is guided by the dispersion plane 1g.

The above-described topside spray fluid and bottom-side spray fluid press on the spray fluid flowing through the center. The upper dispersion plane 1h is retracted markedly upward, and therefore does not affect the flow of the spray fluid 2 from the injection port 1b.

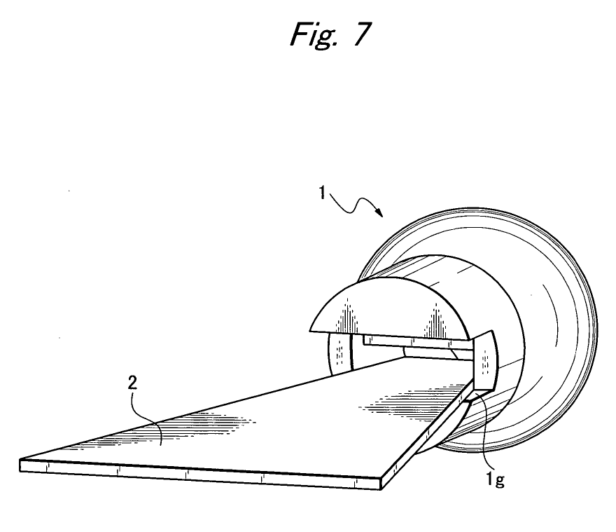

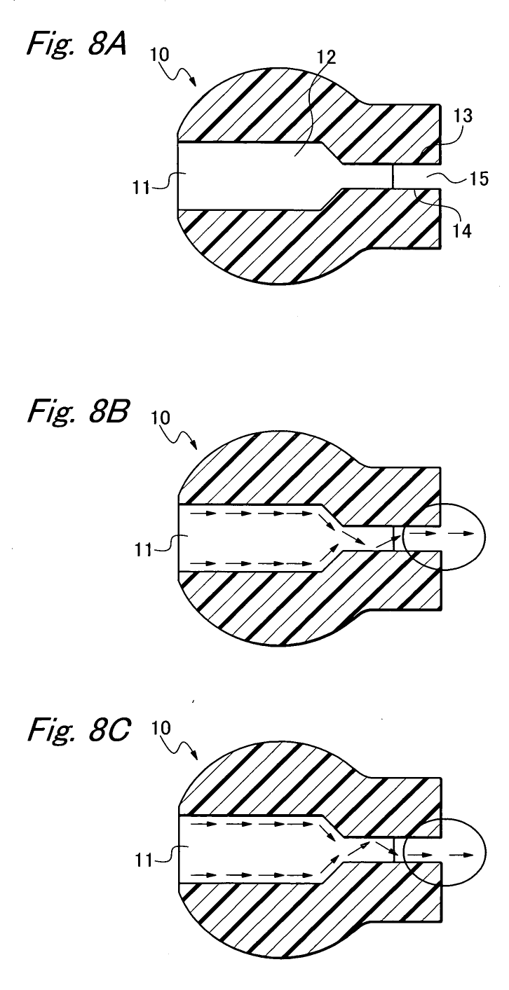

The spray nozzle 1 constructed as described above is, for example, as shown in FIG. 6, pressed into so as to engage a spherical seat support part in an injection port part of a washer nozzle 3 of an automobile. Then, by supplying spray fluid to the supply port 1a with a supply pump, as shown in FIG. 7 the spray fluid 2 that flows along the dispersion plane 1g of the spray nozzle 1 forms a plane of substantially uniform thickness and is sprayed stably without flutter.

As many apparently widely different embodiments and variations of the present invention can be made without departing from the spirit and scope thereof, it is to be understood that the present invention is not limited to the specific embodiments thereof described herein but rather only to the extent set forth in the following claims.

What is claimed is:

1. A spray nozzle comprising an injection port formed long from side to side, a flow path formed cylindrical between a supply port and the injection port, the flow path having a taper section formed on the middle thereof, reducing the flow path cross-sectional area gradually and a tip end being reached to the injection port,
wherein upper and lower positions of the taper section at an end portion on the injection port side are offset with respect to each other in the direction of the axis of the flow path.

2. The spray nozzle according to claim 1, wherein a substantially horizontal dispersion plane part along the axis of the flow path is provided at least ahead of a flow stream produced by upper or lower inner circumferential wall surface of the taper section whose end position in the direction of the axis of the flow path is doser to the injection port.

3. The spray nozzle according to claim 2, wherein a dispersion plane part is retracted in a direction perpendicular to the axis of the flow path so as not to guide the spray fluid ahead of a flow stream produced by upper or lower inner circumferential wall surface of the taper section whose end position in the direction of the axis of the flow path is farther from the injection port.
